(19) United States
(12) Patent Application Publication
(10) Pub. No.: US 2026/0128240 A1
(43) Pub. Date: May 7, 2026

(54) GLASS-TO-METAL-SEAL ASSEMBLY FOR AN ELECTROMECHANICAL SWITCHING DEVICE

(71) Applicant: SENSATA TECHNOLOGIES, INC., ATTLEBORO, MA (US)

(72) Inventors: ALEKSANDAR PETROV MIHAYLOV, SOFIA (BG); MICHAEL JOSEPH SANGERMANO, PROVIDENCE, RI (US)

(21) Appl. No.: 18/936,208

(22) Filed: Nov. 4, 2024

(51) Int. Cl. H01H 9/02; H01H 1/14; H01H 11/00

(52) U.S. Cl. CPC H01H 9/02; H01H 1/14; H01H 11/00

(57) ABSTRACT

This disclosure presents apparatuses, systems, and devices that include a glass-to-metal-seal (GTMS) header for a low-voltage auxiliary switch. In one embodiment, an apparatus is disclosed that includes a weld plate and a plurality of glass-to-metal-seal (GTMS) headers. Each GTMS header is inserted into the weld plate. In this embodiment, the apparatus also includes a plurality of bendable conductive inserts, each bendable conductive insert extending through one GTMS header of the plurality of GTMS headers.

### FIELD OF THE TECHNOLOGY

The subject disclosure relates to apparatus, systems, and devices that include a glass-to-metal-seal assembly for an electromechanical switching device.

### BACKGROUND

Electromechanical switching devices, such as contactors and relays, are crucial components within electrical systems, tasked with efficiently managing the flow of electrical current between fixed contacts. In a typical configuration, a contactor includes a main switch having a moveable assembly configured to create or break the connection between the fixed contacts in response to movement of the actuator/plunger assembly. High-voltage contactors often include a hermetically sealed arc chamber that aids in the arc breaking characteristics of the contactor.

Contactors and other similar devices sometimes also include an auxiliary switch to confirm the state of the main switch (open/closed). The auxiliary switch is typically mechanically coupled to the actuator, which is located inside the contactor's hermetically sealed arc chamber. In order to pass a low voltage signal from the inside to the outside of the hermetic chamber, this signal is often transferred using pins sealed with a glass to metal seal (GTMS). This GTMS is often done on large metal weld plates commonly found on hermetically sealed contactors. GTMS are created at high temperature, and the size of header directly influences process throughput. GTMS pins are also prone to damage and must be carefully handled, especially difficult when small pins are sealed to a large plate.

### SUMMARY

This disclosure presents apparatuses, systems, and devices that include a glass-to-metal-seal (GTMS) assembly for an electromechanical switching device. Embodiments of the present disclosure replace the use of a large sealing piece for a smaller GTMS header that is welded into the larger structure. This reduces the cost and complexity of the overall assembly because the processing and material selection is on a small plate instead of the larger plate. Furthermore, this removes the risk of handling damage since the plates are smaller relative to the pins, and more can be fit on trays and more easily handled.

In a particular embodiment, an apparatus is disclosed that includes a weld plate and a plurality of glass-to-metal-seal (GTMS) headers. Each GTMS header is inserted into the weld plate. In this embodiment, the apparatus also includes a plurality of bendable conductive inserts in which each bendable conductive insert extends through one GTMS header of the plurality of GTMS headers.

In another embodiment, an apparatus is disclosed that includes a weld plate and a main switch. The main switch includes at least two main stationary contacts and a moveable contact for opening and closing a connection between the at least two stationary contacts. The main switch also includes a moveable assembly configured to move the moveable contact into an open state in which the connection between the at least two stationary contacts is open and a closed state in which the connection between the at least two stationary contacts is closed. In this embodiment, the electromechanical switching device assembly also includes an auxiliary switch. The auxiliary switch includes a first set of terminals and a plurality of glass-to-metal-seal (GTMS) headers. Each GTMS header is inserted into the weld plate and has a bendable conductive insert extending through the GTMS header. The bendable conductive inserts is positioned such that one end of each of the bendable conductive inserts is in a position to make or break a connection with the first set of terminals in response to movement of the auxiliary switch. When the connection between the first set of terminals and the auxiliary switch is closed, the auxiliary switch provides a signal that indicates a state of the moveable contact.

In another embodiment, a method of assembling a glass-to-metal-seal assembly for an electromechanical switching device is disclosed that includes inserting into a weld plate of an electromechanical switching device, a plurality of glass-to-metal-seal (GTMS) headers. Each GTMS header has a bendable conductive insert extending through the GTMS header. In this embodiment, the method also includes welding each GTMS header to the weld plate to form a hermetically sealed arc chamber and bending one end of each of the bendable conductive inserts such that the end of the bendable conductive insert is in a position to make or break a connection with terminals of an auxiliary switch of the electromechanical switching device in response to movement of the auxiliary switch.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1A is a diagram illustrating a cross-sectional view of a glass-to-metal-seal (GTMS) assembly for an electromechanical switching device in accordance with at least one embodiment of the present disclosure.

FIG. 1B is a diagram illustrating an isometric view of the GTMS assembly of FIG. 1A.

FIG. 2A is a diagram illustrating a top view of a GTMS assembly.

FIG. 2B is a diagram illustrating a bottom view of the GTMS assembly of FIG. 2A.

FIG. 3 is a diagram illustrating the GTMS assembly of FIG. 2A with the addition of a plurality of overmoldings.

FIG. 4 is a diagram illustrating a cross-sectional view of an example electromechanical switching device for integrating with the GTMS assembly of FIG. 2A in accordance with at least one embodiment of the present disclosure.

FIG. 5A is a diagram illustrating a cross-sectional view of a portion of an electromechanical switching device assembly that includes the electromechanical switching device of FIG. 4 with the addition of the GTMS assembly of FIG. 2A and an auxiliary switch in the closed state in accordance with at least one embodiment of the present disclosure.

FIG. 5B is a diagram illustrating a cross-sectional top view of a portion of the electromechanical switching device assembly of FIG. 5A with the auxiliary switch in the closed state.

FIG. 5C is a diagram illustrating a cross-sectional side view of a portion of the electromechanical switching device assembly of FIG. 5A with the auxiliary switch in the open state.

FIG. 5D is a diagram illustrating a cross-sectional side view of a portion of the electromechanical switching device assembly of FIG. 5A with the auxiliary switch in the closed state.

FIG. 6 is a diagram illustrating a flowchart of an example method for assembling a GTMS assembly in accordance with at least one embodiment of the present disclosure.

FIG. 7 is a diagram illustrating a flowchart of an example method for assembling a GTMS assembly in accordance with at least one embodiment of the present disclosure.

### DETAILED DESCRIPTION

The terminology used herein for the purpose of describing particular examples is not intended to be limiting for further examples. Whenever a singular form such as “a”, “an” and “the” is used and using only a single element is neither explicitly nor implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises”, “comprising”, “includes” and/or “including”, when used, specify the presence of the stated features, integers, steps, operations, processes, acts, elements and/or components, but do not preclude the presence or addition of one or more other features, integers, steps, operations, processes, acts, elements, components and/or any group thereof.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e., only A, only B, as well as A and B. An alternative wording for the same combinations is “at least one of A and B”. The same applies for combinations of more than two elements.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

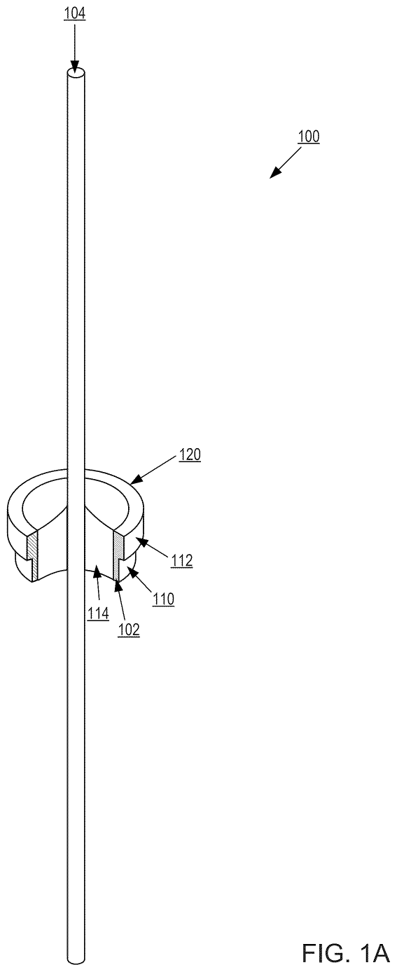

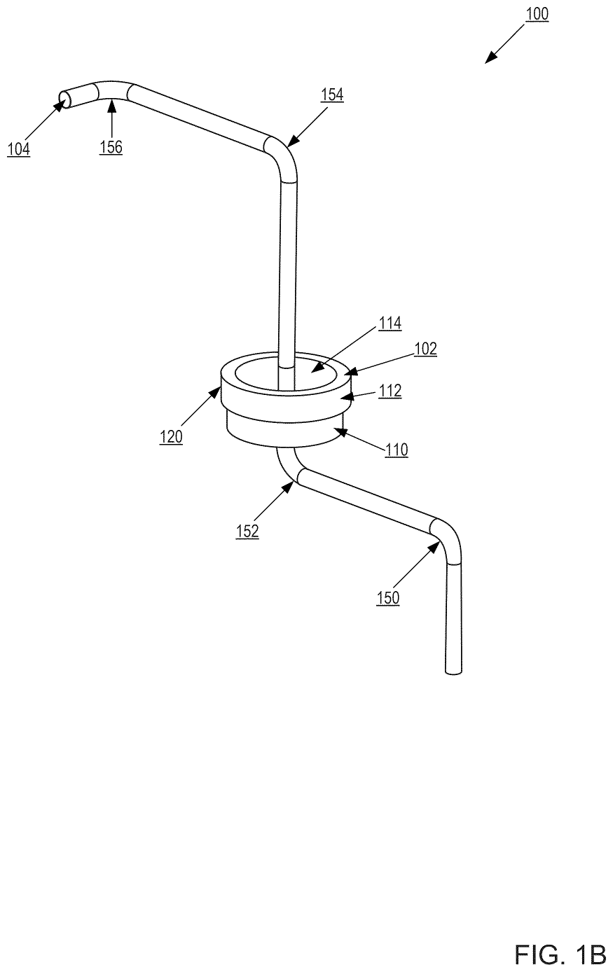

For further explanation, FIG. 1A sets forth a diagram illustrating a cross-sectional view of a glass-to-metal-seal (GTMS) assembly 100 for an electromechanical switching device. FIG. 1B sets forth a diagram illustrating an isometric view of the GTMS assembly 100 of FIG. 1A. The GTMS assembly 100 includes a GTMS header 120 having a cylindrical metal insert 102 with an open center. In the example of FIGS. 1A and 1B, the cylindrical metal insert 102 includes a first circular portion 110 and a second circular portion 112. The first circular portion 110 has a smaller diameter than the second circular portion 112. As will be explained below, the diameter of the first circular portion is selected to match the diameter of a hole in a weld plate, such that the first circular portion can be inserted into the hole of the weld plate and the second circular portion extends out from the weld plate.

The GTMS assembly 100 also includes a bendable conductive insert 104 that extends through the open center of the cylindrical metal insert 102. The bendable conductive insert 104 is a metal conductor that can transmit an electrical signal. In the example of FIG. 1A, the bendable conductive insert 104 is illustrated as a straight conductor or pin. The bendable conductive insert 104 may be shaped or bent to align with external terminals, such as terminals of an auxiliary contact system within a hermetically sealed arc chamber of an electromechanical switching device. For example, FIG. 1A illustrates the bendable conductive insert 104 with a number of bends 150, 152, 154, 156.

In FIGS. 1A and 1B, the open center of the cylindrical metal insert 102 is filled with glass 114 that couples the bendable conductive insert 104 to the GTMS header 120 and seals the open center of the cylindrical metal insert 102. Glass-to-metal seals are a type of mechanical seal which joins glass and metal surfaces. The glass and metal materials are selected based on their compatible coefficients of thermal expansion to prevent stress and cracking during heating and cooling. In a particular embodiment, the inside of the cylindrical metal insert is treated or coated to enhance adhesion and both the glass and the metal are heated. As the glass softens and becomes pliable, it flows around the metal part, forming the seal. Once the materials are properly fused, the assembly is slowly cooled to prevent thermal shock, resulting in a durable, airtight seal.

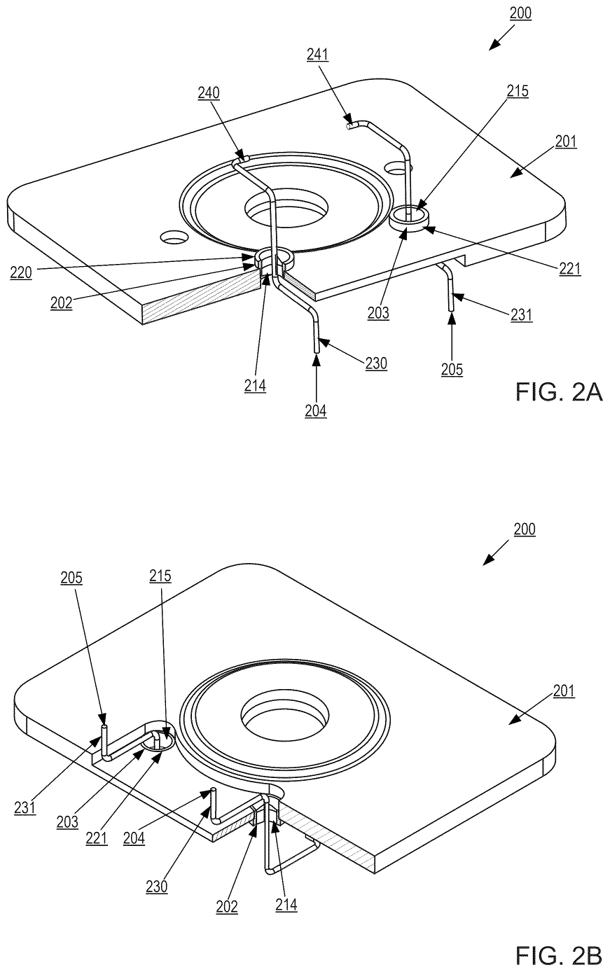

For further explanation, FIG. 2A sets forth a diagram illustrating a top view of a GTMS assembly 200. FIG. 2B sets forth a diagram illustrating a bottom view of the GTMS assembly 200 of FIG. 2A. The GTMS assembly 200 of FIGS. 2A and 2B includes a first GTMS header 220 and a second GTMS header 221, which are both inserted into a weld plate 201. As with the GTMS header 120 of FIGS. 1A and 1B, each GTMS header 220, 221 includes a cylindrical metal insert 202 with an open center through which a bendable conductive insert 204, 205 extends. Each of the GTMS headers 220, 221 also includes a GTMS 214, 215 that seals the bendable conductive inserts 204, 205 to the cylindrical metal inserts 204, 205. As will be explained below, the ends 240, 241, 230, 231 of the bendable conductive inserts 204, 205 are configured to couple to external terminals such that the GTMS headers 204, 205 transmit a signal through the weld plate 201.

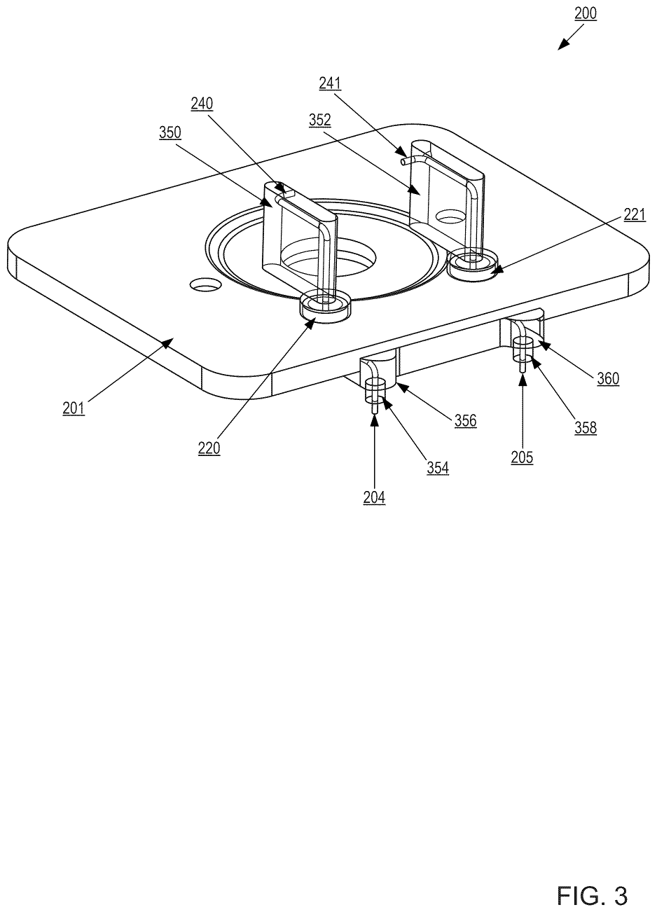

For further explanation, FIG. 3 sets forth a diagram illustrating the GTMS assembly 200 of FIG. 2A with the addition of a plurality of overmoldings 350, 352, 354, 356, 358, 360. In a particular embodiment, the overmolding process includes preparing the surface to be coated to ensure adhesion; placing the components into a mold designed for the overmolding process; overmolding material (e.g., a thermoplastic elastomer (TPE) or a Thermoplastic Polyurethane (TPU) is heated and injected into the mold cavity, where it flows around the part to be coated; and after injection, the mold is cooled to solidify the overmold material such that the overmold is securely bonded to the surface.

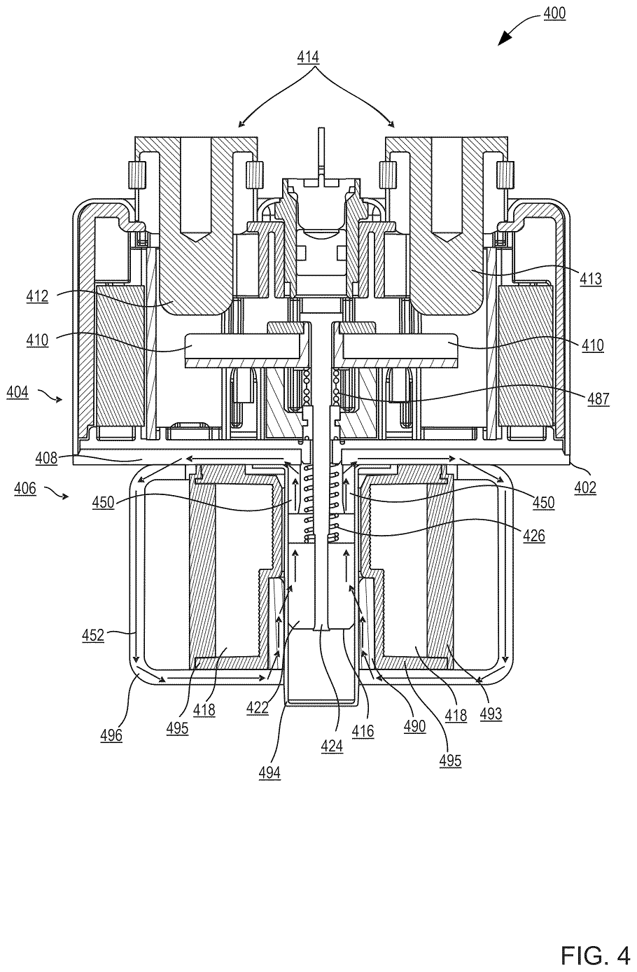

For further explanation, FIG. 4 sets forth a diagram illustrating a cross-sectional view of an example electromechanical switching device 400 which in a particular embodiment is coupled to a GTMS assembly (not pictured in FIG. 4), such as the GTMS assembly 200 of FIG. 2A, for relaying an auxiliary contact signal.

The switching device 400 of FIG. 4 includes an upper coil yoke 408 that separates an upper portion 404 and a lower portion 406 of a housing 402. The switching device also includes a lower coil yoke 496 that surround a coil assembly 493 that includes a plunger tube 494 and a coil enclosure 495. A lower static core 490 is positioned between the plunger tube 494 and the coil enclosure 495. The coil enclosure 495 surrounds a coil (e.g., solenoid) 418 and the plunger tube 494 surrounds a moveable assembly having a plunger 422 coupled to a plunger shaft 424. The upper coil yoke 408 is coupled to an upper flux tube 450 and a plunger spring 426 is coupled between the upper coil yoke 408 and the plunger 422. The switching device 400 also includes fixed contacts 412, 413 and a moveable contact 410. The moveable contact 410 is a main switch that creates or breaks the connection between the fixed contacts 412, 413 in response to movement of the moveable assembly. The fixed contacts 412, 413 are coupled to external connections 414 for coupling with external components, such as a power supply and an electrical application.

In the open state, the moveable contact 410 is not in contact with the fixed contacts 412, 413, such that no current flows between the fixed contacts 412, 413. In this open state, the plunger spring 426 is configured to apply a pre-load force on the plunger 422 to prevent the moveable assembly from moving to a closed state. In the closed state, the moveable contact 410 is in contact with the fixed contacts 412, 413 such that current flows between the fixed contacts 412, 413 through the moveable contact 410.

The coil 418 consists of windings of conductive material such as copper or aluminum. When the coil 418 is connected to a power source and current flows through the windings, a strong magnetic field is generated that flows through the magnetic circuit pathways of the electromechanical switching device. This electromagnetic field is guided by the coil yoke and static core(s) which are made of ferromagnetic materials such as low-carbon steel. This path that the magnetic field travels on is known as the magnetic circuit 452, illustrated in FIG. 4 by arrows. The magnetic field is guided to the plunger 422, which resides within the enclosed plunger tube 494, and magnetizes it. The magnetized plunger 422 is then attracted by a magnetic force to the upper flux tube 450. The magnetic field forces the plunger 422 with upper direction. When enough magnetic force is generated, the plunger 422 will overcome any retaining spring forces (pre-load force from the plunger spring 426) and begin to move. The plunger 422 and the plunger shaft 424 drive the moveable contact 410 toward the fixed contacts 412, 413 until the moveable contact 410 is in a closed position in which contact is established between the moveable contact 410 and the fixed contacts 412, 413, thus transitioning the switching device assembly 400 from the open state to the closed state. When the moveable contact touches the stationary contacts, the high-voltage circuit is closed. At this time there is still an air gap between the plunger and the and the upper flux tube. If the magnetic force between the plunger and upper flux tube is above the pre-load force that was applied to the contact spring 487, the contact spring 487 is compressed and the plunger moves to a position where the air gap between the plunger and upper flux tube is essentially zero. When the plunger 422 contacts the upper flux tube 450, the magnetic circuit 452 is closed.

When the coil 418 is disconnected from the low-voltage power source, the ferromagnetic components lose their magnetization and the magnetic force on the plunger decreases. This decrease in magnetic field, separates the plunger 422 from the upper flux tube, opening the magnetic circuit 452. The plunger spring 426 returns the plunger to its original position. That is, when the coil 118 is de-energized, the plunger 422 is driven downward from the force of the energy stored in the compressed plunger spring 426 and the contact spring 487, and the moveable assembly pulls the moveable contact 410 downward until the moveable contact 410 is in an open position, thus breaking the high voltage circuit between the moveable contact 410 and the fixed contacts 412, 413. A controller (not shown in FIG. 4) may be coupled to the switching device 400 and configured to control a current flowing to the coil 418 of the switching device.

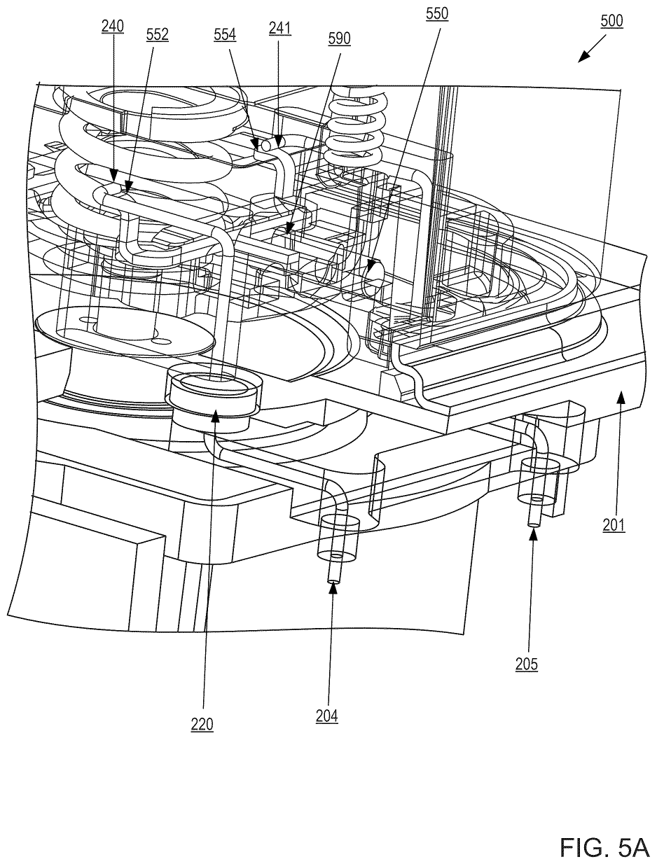

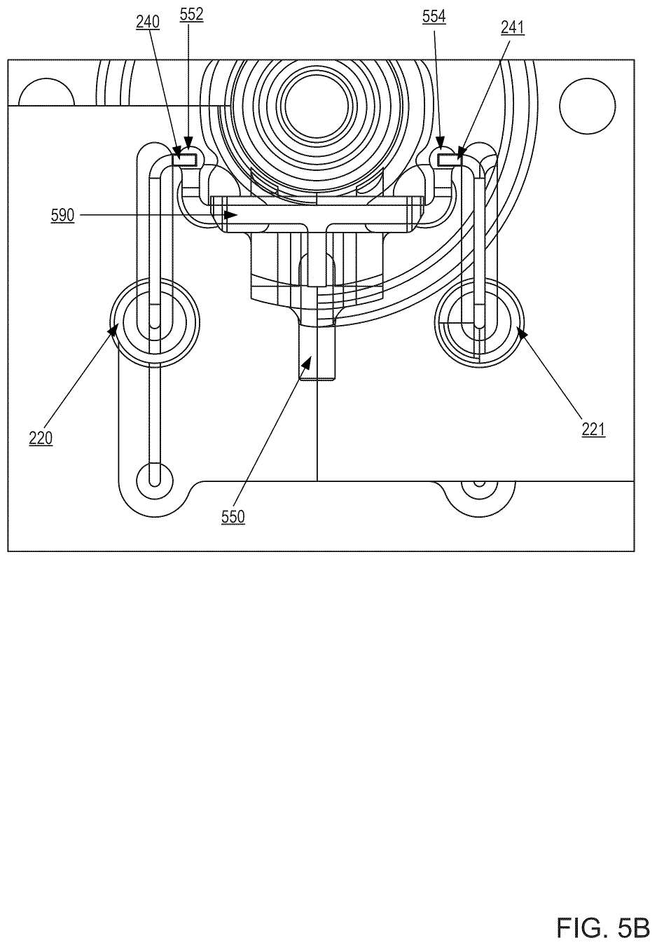

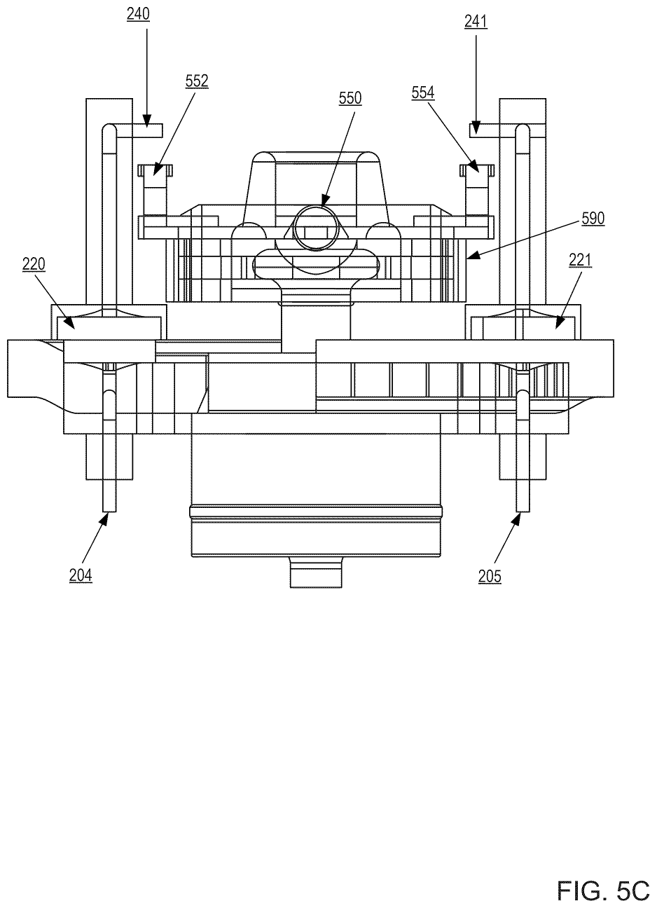

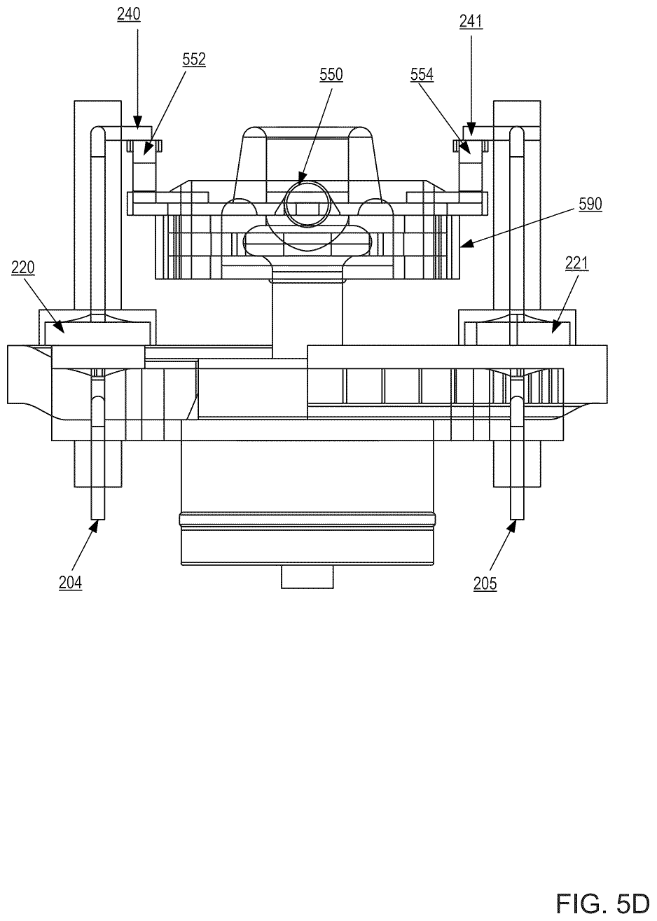

A typical switching device or contactor, such as the one illustrated in FIG. 4, may also include an auxiliary switch (not pictured) that is mechanically coupled to the actuator and configured to provide a signal used as confirmation of the state (opened/closed) of the main switch. As will be explained below in FIG. 5, a GTMS assembly may be coupled to an auxiliary switch to relay the auxiliary contact signal of the auxiliary switch to terminals external to the switching device.

For further explanation, FIG. 5A sets forth a diagram illustrating a cross-sectional view of a portion of an electromechanical switching device assembly 500 that includes the electromechanical switching device 400 of FIG. 4 with the addition of the GTMS assembly 200 of FIG. 2A and an auxiliary switch 590 in the closed state. FIG. 5B sets forth a diagram illustrating a cross-sectional top view of a portion of the electromechanical switching device assembly 500 of FIG. 5A with the auxiliary switch 590 in the closed state. FIG. 5C sets forth a diagram illustrating a cross-sectional side view of a portion of the electromechanical switching device assembly 500 of FIG. 5A with the auxiliary switch 590 in the open state. FIG. 5D sets forth a diagram illustrating a cross-sectional side view of a portion of the electromechanical switching device assembly 500 of FIG. 5A with the auxiliary switch 590 in the closed state.

For ease of explanation and illustration, not all components of the switching device 400, the auxiliary switch 590, and the GTMS assembly 200 are visible or referenced. In the example of FIG. 5, the upper coil yoke 408 (not pictured) of the switching device 400 serves as the weld plate 201 of the GTMS assembly 200 such that the GTMS header 220 of the GTMS assembly 200 is welded into the upper coil yoke 408 of the switching device 400, forming a hermetic seal for the arc chamber of the switching device. Readers of skill in the art that other components of the switching device may be selected for inserting the GTMS headers, so that an auxiliary switch signal may be transmitted through a hermetically sealed chamber.

Although not depicted entirely in FIG. 5, as explained in FIG. 4, the electromechanical switching device 400 includes a main switch with the two stationary contacts 412, 413 and the moveable contact 410 for opening and closing connections with the two stationary contacts 412, 413. The main switch of the electromechanical switching device 400 includes a moveable assembly configured to move the moveable contact 410 into an open state in which the connection between the two stationary contacts 412, 413 is open and a closed state in which the connection between the two stationary contacts 412, 413 is closed.

The example auxiliary switch 590 of FIG. 5 includes a first terminal 552 configured to make or break a connection with one end 240 of the first bendable conductive insert 204 extending through the first GTMS header 220 and a second terminal 554 configured to make or break a connection to one end 241 of the second bendable conductive insert 205 extending through the second GTMS header 221. The auxiliary switch 590 also includes a pin 550 coupled to the moveable assembly of the main switch such that the pin moves in response to movement of the moveable assembly. In a particular embodiment, closing the connection between the bendable inserts and the auxiliary switch generates a signal that indicates a state of the moveable contact. This signal is then transmitted through the GTMS headers 220, 221 to the opposite ends 230, 231 of the bendable conductive inserts 204, 205. Readers of skill in the art will realize that FIG. 5 illustrates just one example embodiment of the present disclosure and the GTMS assembly 200 may be coupled to different configurations (e.g., open, closed) of auxiliary switches and switching devices.

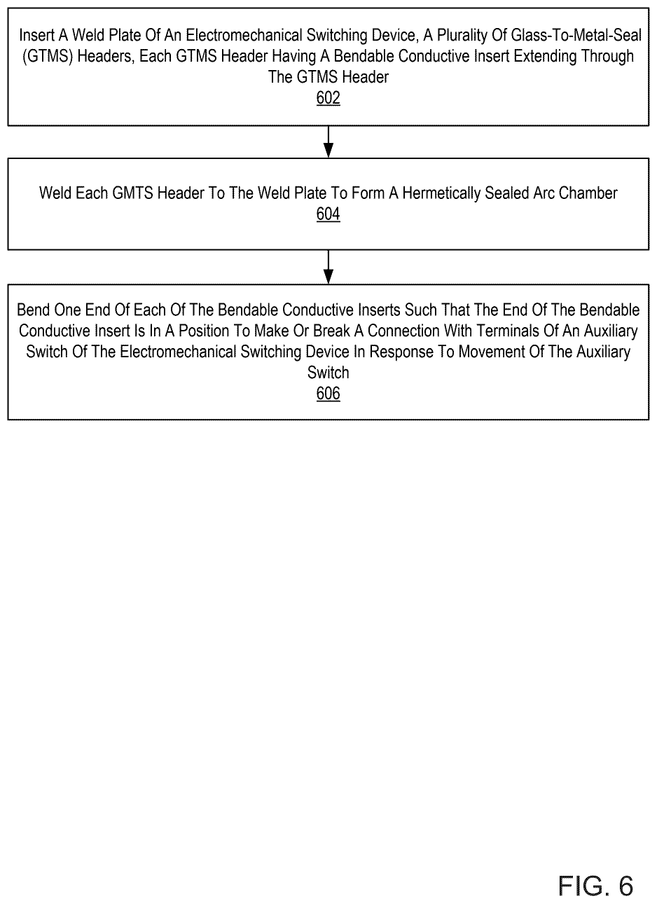

For further explanation, FIG. 6 sets forth a flowchart of an example method for assembling an electromechanical switching device assembly in accordance with at least one embodiment of the present disclosure. The method of FIG. 6 includes inserting 602 into a weld plate of an electromechanical switching device, a plurality of glass-to-metal-seal (GTMS) headers. In this embodiment, each GTMS header having a bendable conductive insert extending through the GTMS header. Inserting 602 a plurality of glass-to-metal-seal (GTMS) headers into a weld plate of an electromechanical switching device may be carried out by aligning a first circular portion of a cylindrical metal insert with a hole in the weld plate; pushing the first circular portion into the weld plate until the second circular portion of the cylindrical metal insert is in contact with the surface of the weld plate. In this example, the second circular portion is larger than the first circular portion. In alternative configurations in which the cylindrical metal insert has a single circular portion, the metal insert may be inserted partially into the hole.

The method of FIG. 6 also includes welding 604 each GTMS header to the weld plate to form a hermetically sealed arc chamber. Welding 604 each GTMS header to the weld plate to form a hermetically sealed arc chamber may be carried out by welding the outer circumference of a circular portion (e.g., the first circular portion) of the cylindrical metal insert to the surface of the weld plate.

In addition, the method of FIG. 6 also includes bending 606 one end of each of the bendable conductive inserts such that the end of the bendable conductive insert is in a position to make or break a connection with terminals of an auxiliary switch of the electromechanical switching device in response to movement of the auxiliary switch. Bending 606 one end of each of the bendable conductive inserts such that the end of the bendable conductive insert is in a position to make or break a connection with terminals of an auxiliary switch of the electromechanical switching device in response to movement of the auxiliary switch may be carried out by bending the conductive inserts to align with the terminals and components of the auxiliary switch.

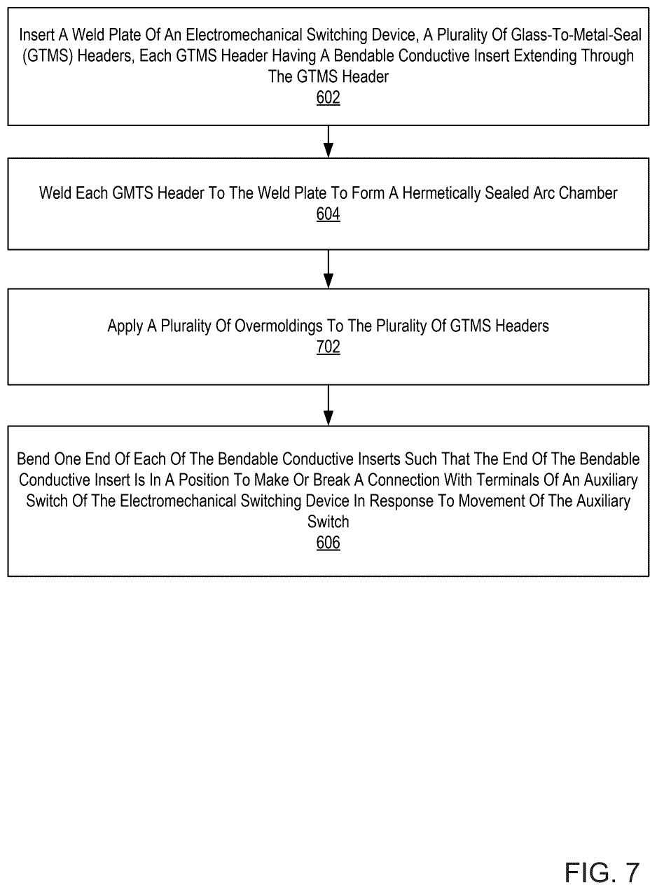

For further explanation, FIG. 7 sets forth a flowchart of an example method for assembling an electromechanical switching device assembly in accordance with at least one embodiment of the present disclosure. The method of FIG. 7 is similar to the method of FIG. 6 in that the method of FIG. 7 includes all of the elements of FIG. 6. In addition, the method of FIG. 6 includes applying 702 a plurality of overmoldings to the plurality of GTMS headers. Applying 702 a plurality of overmoldings to the plurality of GTMS headers may be carried out by preparing the surface to be coated (e.g., portions of the exposed components of the GTMS assembly) to ensure adhesion; placing the components into a mold designed for the overmolding process; overmolding material (e.g., a thermoplastic elastomer (TPE) or a Thermoplastic Polyurethane (TPU)) is heated and injected into the mold cavity, where it flows around the part to be coated; and after injection, the mold is cooled to solidify the overmold material such that the overmold is securely bonded to the surface.

Replacing the use of a large sealing piece for a smaller GTMS header that is welded into the weld plate of a switching device, reduces the cost and complexity of the overall assembly because the processing and material selection is on a small plate instead of the larger plate. Furthermore, this removes the risk of handling damage since the plates are smaller relative to the pins, and more can be fit on trays and more easily handled.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. An apparatus comprising:
a weld plate;
a plurality of glass-to-metal-seal (GTMS) headers, each GTMS header inserted into the weld plate; and
a plurality of bendable conductive inserts, each bendable conductive insert extending through one GTMS header of the plurality of GTMS headers.

2. The apparatus of claim 1, wherein each GTMS header includes:
a cylindrical metal insert having an open center in which a bendable conductive insert of the plurality of bendable conductive inserts extends through; and
glass within the open center that seals the bendable conductive insert to the cylindrical metal insert.

3. The apparatus of claim 2 wherein each cylindrical metal insert includes:
a first circular portion for inserting into the weld plate; and
a second circular portion that extends out from the weld plate; the first circular portion having a smaller diameter than the second circular portion.

4. The apparatus of claim 1, wherein each GTMS header is welded to the weld plate.

5. The apparatus of claim 1 further comprising a plurality of overmoldings, each overmolding surrounding a portion of a GTMS header.

6. The apparatus of claim 5, wherein each overmolding surrounds a portion of the bendable conductive insert extending through the GTMS header.

7. The apparatus of claim 1, wherein each bendable conductive insert is positioned such that one end of each of the bendable conductive inserts is in a position to make or break a connection with an auxiliary switch in response to movement of the auxiliary switch; wherein when the connection with the auxiliary switch is closed, the auxiliary switch provides a signal that indicates a state of the moveable contact.

8. An apparatus comprising:
a weld plate;
a main switch that includes:
at least two main stationary contacts;
a moveable contact for opening and closing a connection between the at least two stationary contacts; and
a moveable assembly configured to move the moveable contact into an open state in which the connection between the at least two stationary contacts is open and a closed state in which the connection between the at least two stationary contacts is closed; and
an auxiliary switch that includes:
a first set of terminals;
a plurality of glass-to-metal-seal (GTMS) headers, each GTMS header inserted into the weld plate and having a bendable conductive insert extending through the GTMS header, the bendable conductive inserts positioned such that one end of each of the bendable conductive inserts is in a position to make or break a connection with the first set of terminals in response to movement of the auxiliary switch; and
wherein when the connection between the first set of terminals and the auxiliary switch is closed, the auxiliary switch provides a signal that indicates a state of the moveable contact.

9. The apparatus of claim 8, wherein each GTMS header of the plurality of GTMS headers includes:
a cylindrical metal insert having an open center in which a bendable conductive insert of the plurality of bendable conductive inserts extends through; and
glass within the open center that seals the bendable conductive insert to the cylindrical metal insert.

10. The apparatus of claim 9, wherein each cylindrical metal insert includes:
a first circular portion for inserting into the weld plate; and
a second circular portion that extends out from the weld plate; the first circular portion having a smaller diameter than the second circular portion.

11. The apparatus of claim 8, wherein each GTMS header is welded to the weld plate.

12. The apparatus of claim 8 further comprising a plurality of overmoldings, each overmolding surrounding a portion of a GTMS header.

13. The apparatus of claim 12, wherein each overmolding surrounds a portion of the bendable conductive insert extending through the GTMS header.

14. The apparatus of claim 8, wherein each bendable conductive insert is coupled at one end to an auxiliary contact switch of an electromechanical switching device.

15. A method of assembling a glass-to-metal-seal assembly for an electromechanical switching device, the method comprising:
inserting into a weld plate of an electromechanical switching device, a plurality of glass-to-metal-seal (GTMS) headers, each GTMS header having a bendable conductive insert extending through the GTMS header;
welding each GTMS header to the weld plate to form a hermetically sealed arc chamber; and
bending one end of each of the bendable conductive inserts such that the end of the bendable conductive insert is in a position to make or break a connection with terminals of an auxiliary switch of the electromechanical switching device in response to movement of the auxiliary switch.

16. The method of claim 15 further comprising:
applying a plurality of overmoldings to the plurality of GTMS headers.

17. The method of claim 16, wherein each overmolding surrounds a portion of the bendable conductive insert extending through the GTMS header.

18. The method of claim 15, wherein each GTMS header includes:
a cylindrical metal insert having an open center in which a bendable conductive insert of the plurality of bendable conductive inserts extends through; and
glass within the open center that seals the bendable conductive insert to the cylindrical metal insert.

19. The method of claim 15 wherein each cylindrical metal insert includes:
a first circular portion for inserting into the weld plate; and
a second circular portion that extends out from the weld plate; the first circular portion having a smaller diameter than the second circular portion.

20. The method of claim 15 further comprising:
coupling another end of each of the bendable conductive inserts to outputs of the electromechanical switching device.
